(19) United States
(12) Patent Application Publication
(10) Pub. No.: US 2023/0313665 A1
(43) Pub. Date: Oct. 5, 2023

(54) DETECTION OF POTENTIAL GEOLOGICAL CONTROL POINTS WITH LOGGING-WHILE-DRILLING SENSORS

(71) Applicant: Halliburton Energy Services, Inc., Houston, TX (US)

(72) Inventors: Siyang Song, Humble, TX (US); Shahin Tasoujian, Houston, TX (US); Eirik Hansen, Sola (NO); Robert P. Darbe, Tomball, TX (US); Vytautas Usaitis, The Woodlands, TX (US)

(21) Appl. No.: 17/710,740

(22) Filed: Mar. 31, 2022

(51) Int. Cl. E21B 44/00; E21B 47/12; G01V 3/18

(52) U.S. Cl. CPC E21B 44/005; E21B 47/12; G01V 3/18

(57) ABSTRACT

A geosteering subsystem has been designed to detect patterns in measurements that correlate to geological events. A geological event may correspond to a potential control point that geosteering operations may use to make geosteering decisions. The subsystem evaluates obtained measurements against predetermined patterns that correlate to geological events. When a pattern is detected in the measurements, the subsystem labels the depth and corresponding formation property measurements as a potential control point. Once detected, the subsystem can pass on the potential control point for interpretation using various methods such as manual interpretation, performed by a human operator, and automatic interpretation, performed by geosteering software.

### TECHNICAL FIELD

The disclosure generally relates to the field of electric digital data processing (e.g., CPC class G06F). The disclosure also relates to earth drilling (e.g., CPC class E21).

### BACKGROUND

When drilling a wellbore horizontally through a geologic formation, geosteering may be required to keep the wellbore within the target formation. Horizontal wellbores are drilled to increase the wellbore exposure to a target formation. To ensure the wellbore stays within the target formation, geosteering is utilized to determine the boundary depths of the target formation and steer the drill string to avoid penetrating the formation boundaries. Geosteering uses sensor readings including but not limited to emitted gamma rays, resistivity, and density, etc., to assist in determining wellbore position. Geosteering operations will detect and interpret geological control points from sensor readings to interpret the geological formation and make geological models and therefore steering decisions.

### BRIEF DESCRIPTION OF THE DRAWINGS

Embodiments of the disclosure may be better understood by referencing the accompanying drawings.

FIG. 1 is a conceptual diagram of a control point detection system that automatically identifies geological events based on formation measurements that are passed on for interpretation.

FIG. 2 is a flowchart of example operations for interpretation of a potential control point by a human operator.

FIG. 3 is a flowchart of example operations for interpretation of a potential control point by geosteering software.

FIG. 4 is a flowchart of example operations for pattern recognition-based detection of geological events in formation property(ies) measurements.

FIG. 5 is a flowchart example of operations of pattern recognition-based detection of geological events in formation property(ies) measurements.

FIG. 6 illustrates various examples of geological event pattern detection in LWD measurements.

FIG. 7 depicts an example computer system with a pattern-based control point detector to identify potential control points for interpretation.

### DESCRIPTION

The description that follows includes example systems, methods, techniques, and program flows that embody embodiments of the disclosure. However, it is understood that this disclosure may be practiced without these specific details. For instance, this disclosure refers to identifying a potential control point and automatically interpreting the control point to update a geological model in illustrative examples. Aspects of this disclosure can be also applied to identifying a potential control point and manually interpreting the control point to update a geological model. In other instances, well-known instruction instances, protocols, structures, and techniques have not been shown in detail in order not to obfuscate the description.

Overview

Geosteering operations utilize logging while drilling (LWD) measurements to evaluate and interpret the formation(s) being drilled. A geologist or a directional driller may monitor LWD measurements in (quasi) real time to identify geologic events that indicate the wellbore may be approaching/crossing a formation boundary or a geological feature. A location corresponding to a geological event may be a geological/steering control point (i.e., a location within a formation at which a steering adjustment may be made). A geologist can identify control points by identifying specific patterns in the LWD measurements, and then manually interpret that control point using LWD measurements and knowledge of the formation. However, interpretation by a human can be subjective and can introduce errors. If a control point is missed or misinterpreted, an incorrect steering decision could be made.

A geological control point detection and interpretation system (“geosteering subsystem”) has been designed to detect patterns in measurements that correlate to geological events and use techniques (such as human interpretation or statistical analysis) to interpret the geological events corresponding to control points and update a geological model based on the interpretations. Domain knowledge, such as geological and formation knowledge, is used to specify patterns in formation measurements that correlate to geological events that likely correspond to control points. While drilling, the geosteering subsystem evaluates obtained measurements (e.g., logging while drilling (LWD) measurements) against the patterns. If a pattern is detected, the geosteering subsystem labels the corresponding wellbore position and/or measurements as a control point and passes on the measurements for interpretation. The interpretation of the control point can be done manually by a human operator, or automatically by interpretation algorithms. Interpreted control points can then be used to update geological models of the formation(s).

### Example Illustrations

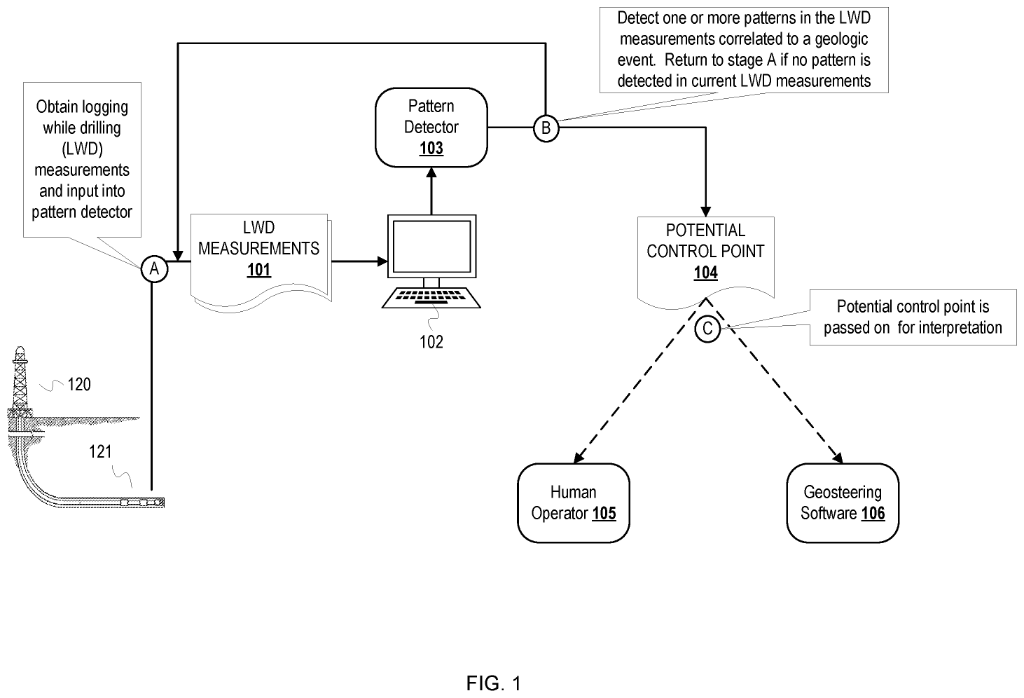

FIG. 1 is a conceptual diagram of a control point detection system that automatically identifies geological events based on formation measurements that are passed on for interpretation. The control point detection system illustrated in FIG. 1 includes a pattern detector 103 and various methods for interpreting the potential control point 104. One or more of these components may be implemented as a distinct method/function, library file(s), a subroutine of a monolithic program, etc. The disclosed system can be implemented with different architectures and/or program organization. The pattern detector 103 detects a control point based on pattern matching against predefined patterns correlated to geological events.

FIG. 1 is annotated with a series of letters A-C. These letters represent stages of operations, each of which can be one or multiple operations. Although these stages are ordered for this example, the stages illustrate one example to aid in understanding this disclosure and should not be used to limit the claims. Subject matter falling within the scope of the claims can vary with respect to the order of some operations.

At stage A, logging while drilling (LWD) measurements 101 are obtained and processed with program code hosted on computer 102. A drilling bottom hole assembly (BHA) 121 of a drilling system 120 generates LWD measurements 101 at various depths while drilling a wellbore. Drilling BHA 121 comprises one or more of gamma ray sensors, resistivity sensors, density sensors, porosity sensors, acoustic sensors, downhole drilling dynamic sensors, at bit inclination (ABI) sensors, and nuclear magnetic resonance sensors that measure the respective formation property(ies) to generate LWD measurements 101 at corresponding depths. LWD measurements 101 may also be obtained from sensors/instruments on surface of drilling system 120 that generate surface logging data such as weight on bit (WOB), torque, rate of penetration (ROP), and gas readings. The LWD measurements 101 assist in determining wellbore positioning with respect to formation boundaries and to assist in propagating a wellbore through a target formation. LWD measurements 101 are input into pattern detector 103.

At stage B, pattern detector 103 analyzes the LWD measurements 101 and detects one or more patterns in the LWD measurements 101 that match at least one predetermined pattern correlated to a geological event (“geological event pattern”). If pattern detector 103 does not detect a pattern in the current set of LWD measurements 101, then operations return to stage A above to obtain new LWD measurements 101 from drilling BHA 121 as the wellbore is drilled. The geological event indicates the wellbore position is near, on, or has penetrated a formation boundary. Such a position would be a control point. A predetermined geological event pattern can be for a formation property or a combination of formation property(ies) measurements. For example, a geologist can specify or define a geological event pattern in gamma ray measurements that correlate to a geological event of a wellbore penetrating a formation boundary. Once a geologic event is identified by pattern detector 103, the wellbore position measurements of the potential geologic event are labeled as a potential control point 104.

At stage C, the potential control point 104 is passed on for interpretation. Interpreting the potential control point 104 comprises interpreting the geology of the formation(s) (i.e., formation properties and corresponding depths) at the potential control point 104 to assist geosteering operations in estimating the position of the wellbore in the formation(s) and making accurate steering decisions. In some instances, the potential control point 104 can be interpreted manually by a human operator 105. Human operator 105 may be a geologist that manually interprets the potential control point 104 by comparing the corresponding well position measurements and geological event pattern(s) to offset well logs and domain knowledge of the target formation. In some instances, the potential control point 104 can be interpreted automatically with geosteering software 106. Geosteering software 106 can include an interpretation algorithm that utilizes statistical analysis, such as Bayesian statistics, for automatically interpreting the potential control point 104.

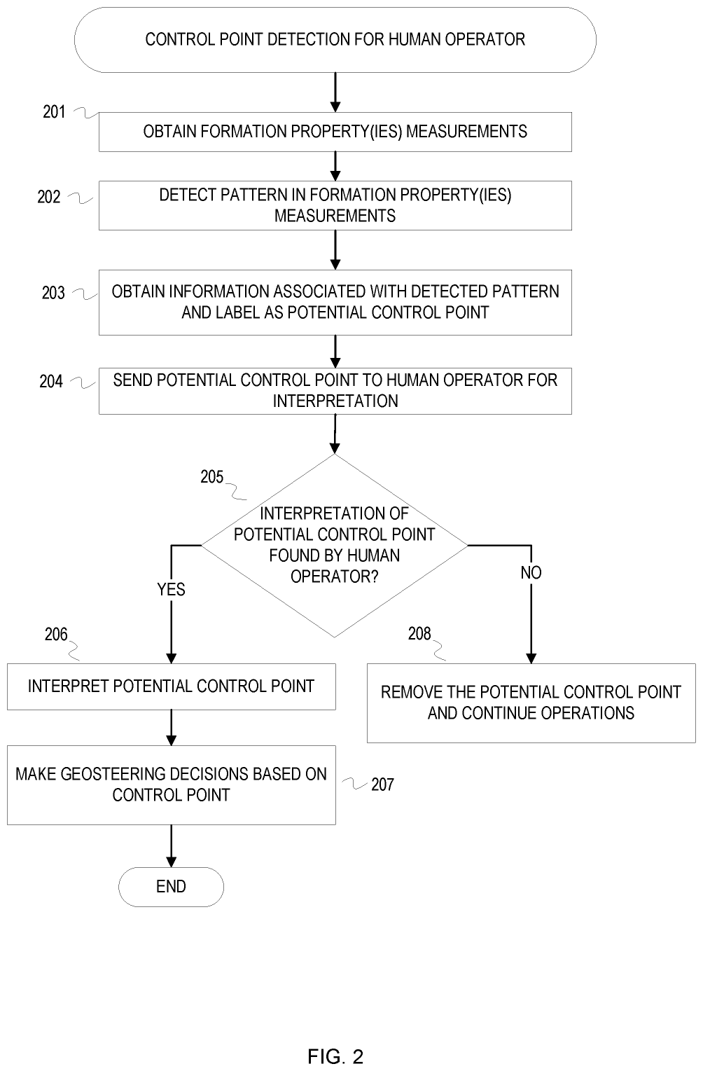

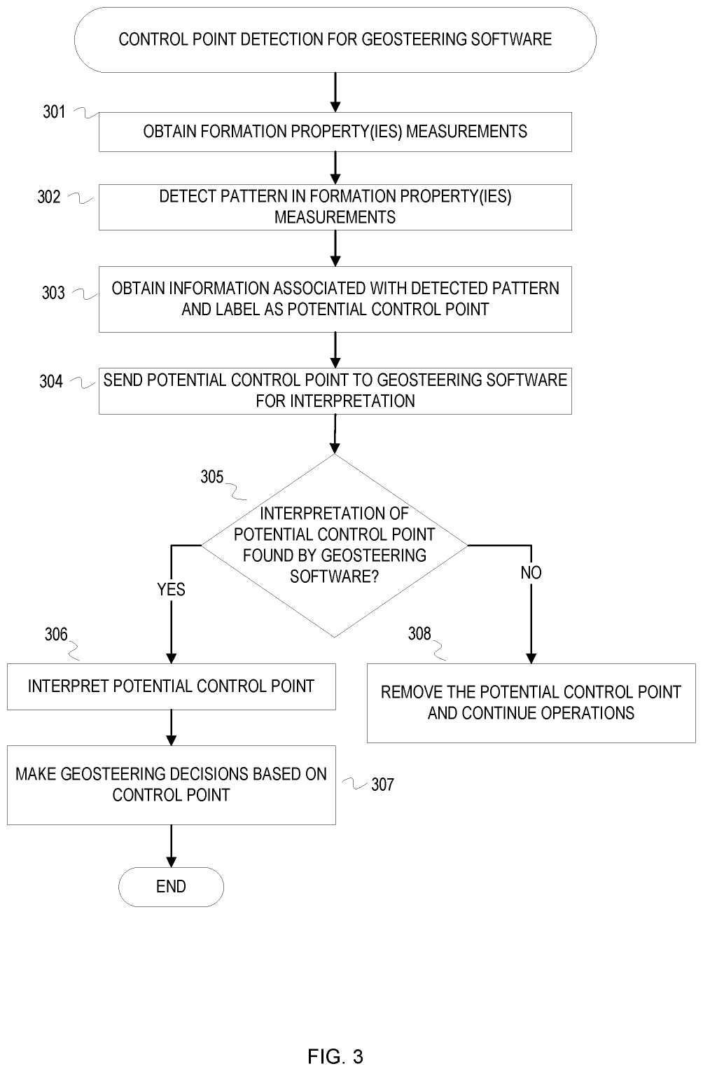

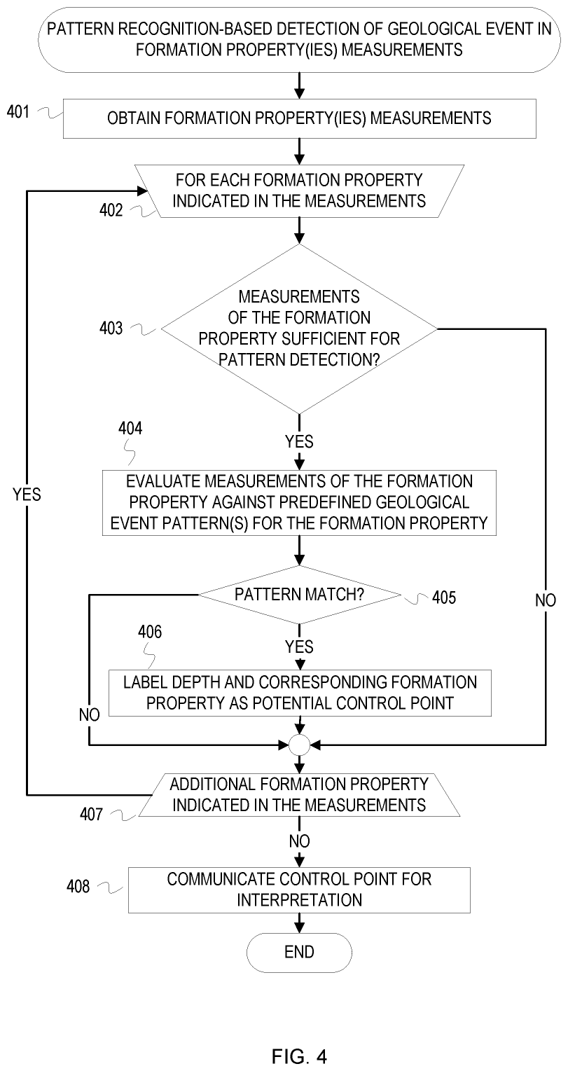

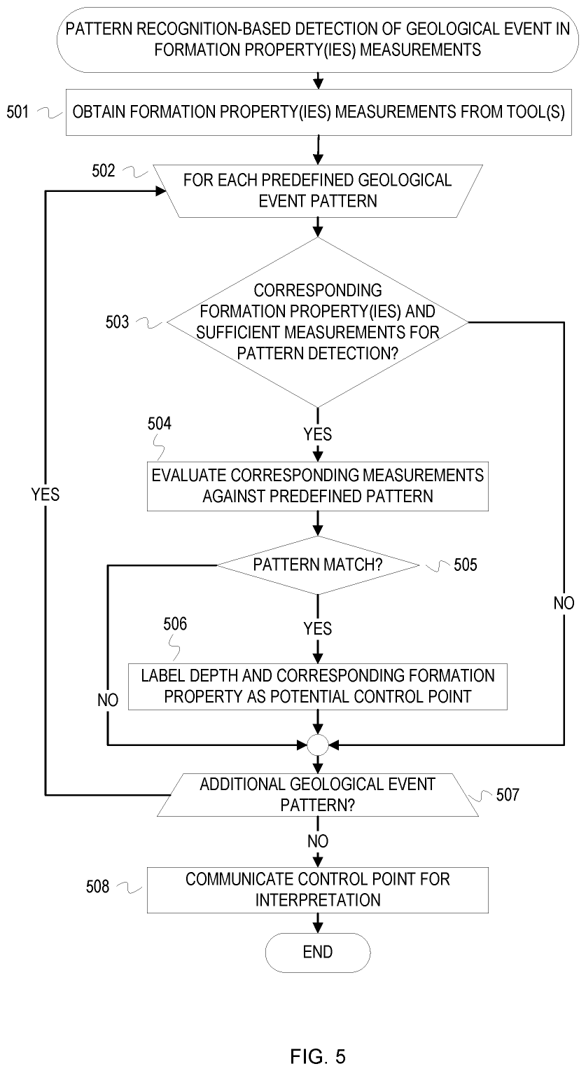

The following FIGS. 2-5 depict flowcharts for various aspects of the disclosed system. FIGS. 2 and 3 are different flowcharts of example operations for interpretation methods of a potential control point. FIGS. 4 and 5 are different flowcharts of example operations for pattern detection-based control point detection. The operations of FIG. 4 iterate over formation property measurements and the operations of FIG. 5 iterate over predetermined patterns to evaluate formation property measurements. The descriptions for these flowcharts refer to a pattern-based control point detector, a human operator, and geosteering software. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 2 is a flowchart of example operations for interpretation of a potential control point by a human operator. The example operations in FIG. 2 are described with reference to a pattern-based control point detector and a human operator.

At block 201, the pattern-based control point detector obtains formation property(ies) measurements from LWD measurements. LWD measurements comprise formation property measurements at a depth/depths. LWD measurements may need to be processed (e.g., filtered, aggregated, etc.) prior to obtaining formation property(ies) measurements.

At block 202, the pattern-based control point detector detects a pattern in the formation property measurements. The pattern can indicate a potential geological event. Patterns can be predetermined and may be based on domain knowledge or offset well data. Patterns may include, but are not limited to, an abrupt change in a single formation property measurement, a separation between two formation property measurements, and separation between a formation property measurement and a pseudo log. Additional details on pattern detection and types of patterns are discussed in the flowcharts below.

At block 203, the pattern-based control point detector obtains information associated with the detected pattern and labels the depth and associated information as a potential control point. Information may include, but is not limited to, the pattern detection type and the corresponding formation property(ies).

At block 204, the pattern-based control point detector sends the potential control point to a human operator for manual interpretation. The human operator can interpret the geology at the potential control point to assist in determining the wellbore position with respect to the geological event and a determine if a geosteering decision is needed.

At block 205, the human operator determines if there is an interpretation for the potential control point. An interpretation of a control point may include analyzing the control point with available data such as pseudo logs and domain knowledge of the target formation. In some instances, data for interpretation may not be available. If an interpretation of the potential control point can be found, then operational flow proceeds to block 206. Otherwise, operational flow proceeds to block 208.

At block 206, the human operator interprets the potential control point. The human operator may interpret the potential control point by determining the formation property measurements and their corresponding depth(s) at the potential control point. The interpreted control point can then be used to assist in geosteering operations.

At block 207, geosteering decisions are made based on the control point. Geosteering decisions may include, but are not limited to, implementing new steering or TVD commands to steer the drill bit away from the target formation boundary.

At block 208, the human operator removes the potential control point and operations continue. The human operator may remove the potential control point from their geological model that can be used for future control point interpretations.

FIG. 3 is a flowchart of example operations for interpretation of a potential control point by geosteering software. The example operations in FIG. 3 are described with reference to a pattern-based control point detector and geosteering software. The operations of FIG. 3 are similar to FIG. 2 but address a scenario of passing a potential control point on to geosteering software for automatic interpretation. In some instances, FIG. 3 may function as a hybrid operation where a human operator may work with or intervene at any point during the operations to influence or correct the decisions and/or interpretations of the geosteering software.

At block 301, the pattern-based control point detector obtains formation property(ies) measurements from LWD measurements. This is similar to block 201 of FIG. 2.

At block 302, the pattern-based control point detector detects a pattern in the formation property measurements. The pattern can indicate a potential geological event. Patterns can be predetermined and may be based on domain knowledge or offset well data.

At block 303, the pattern-based control point detector obtains information associated with the detected pattern and labels the depth and associated information as a potential control point. Information may include, but is not limited to, the pattern detection type and the corresponding formation property(ies).

At block 304, the pattern-based control point detector sends the potential control point to geosteering software for interpretation. The geosteering software may automatically interpret the potential control point and update geological models of the target formation(s). Geosteering software can utilize methods including, but not limited to, Bayesian statistics to interpret the potential control point.

At block 305, the geosteering software determines if there is an interpretation for the potential control point. An interpretation of a control point may include analyzing the control point with available data such as pseudo logs, previous interpreted control points, and seismic data of the target formation. In some instances, data for interpretation may not be available. If the geosteering software can identify data for an interpretation of the potential control point, then operational flow proceeds to block 306. Otherwise, operational flow proceeds to block 308.

At block 306, the geosteering software automatically interprets the potential control point. The geosteering software may interpret the potential control point by determining the formation property measurements at their corresponding depths of the control point. Once interpreted, the geosteering software may then update geological models used for geosteering with the control point.

At block 307, geosteering decisions are made based on the control point. Geosteering decisions may include, but are not limited to, implementing new steering or TVD commands to steer the drill bit away from the target formation boundary.

At block 208, the geosteering software removes the potential control point and operations continue.

FIG. 4 is a flowchart of example operations for pattern recognition-based detection of geological events in formation property(ies) measurements. The example operations in FIG. 4 are described with reference to a pattern-based control point detector.

At block 401, the pattern-based control point detector obtains formation property(ies) measurements. A tool located on a drilling bottom hole assembly (BHA) or on surface has sensors that measure at least one formation property. More likely, multiple tools are used that measure multiple formation properties. Formation properties include, but are not limited to, gamma ray emission, resistivity, matrix density, formation porosity, elasticity determined from acoustic measurements, and nuclear magnetic resonance. LWD measurements comprise formation property measurements at a depth/depths. The formation properties can be measured at a depth corresponding to the respective tool(s) depths. Multiple tools can have different offsets from the drill bit, resulting in obtaining formation property measurements asynchronously for a certain depth. For example, if a resistivity sensor is 30 feet behind a gamma sensor, the corresponding resistivity measurement is first obtained when an additional 30 feet of formation has been drilled after a first gamma ray measurement is obtained. The measurements of formation properties in LWD measurements may include multiple time points. For example, resistivity measurements could be obtained at multiple time points. The multiple time points may be correlated with the depth of the wellbore drilled, thus labeling each resistivity measurement with a depth. The LWD measurements may need to be preprocessed (e.g., filtered, aggregated, etc.) prior to detecting patterns. Processing of the formation property measurements may include drill bit offset calculations, tool calibration factors, and environmental corrections.

At block 402, the pattern-based control point detector begins processing the formation properties indicated in the formation property measurements. The pattern-based control point detector may be configured or set to process a subset of the formation properties indicated in obtained measurements (e.g., a subset of specified logs). The pattern-based control point detector may process all logs loaded into the detector or at a memory/storage location(s) provided to the detector. For instance, LWD measurements may include gamma ray, resistivity, and porosity. The user may only want to process gamma ray and resistivity measurements and not the porosity measurement.

At block 403, the pattern-based control point detector determines if the measurements of the formation property are sufficient for pattern detection. As mentioned before, the measurements may include measurements at multiple time points (i.e., time-series data). The detector may be programmed/configured with a minimum threshold for sufficient measurements in time-series data and/or minimum threshold of depths to process for pattern detection. For instance, to detect an abrupt change in gamma ray measurements, multiple measurements are needed to determine if a gamma ray measurement is out of place compared to the magnitude of the surrounding gamma ray measurements. If measurements are sufficient for pattern detection, then operational flow proceeds to block 404. Otherwise, operational flow proceeds to block 407.

At block 404, the pattern-based control point detector evaluates measurements of the formation property against predefined geological event pattern(s) for the formation property. A geological event may include penetrating a formation boundary or the position of the wellbore is approaching a formation boundary. The geological event pattern can be defined as a function (e.g., a curve) or as a rule or set of one or more conditions in terms of magnitude, rate of change, relative change between logs (e.g., a rate of change percentage or a threshold change). For example, a geologist could set a rule that a geological event pattern is identified when the measurement reads 10% higher than the previous reading. In another instance, a geologist could identify a geological event pattern in the gamma ray measurements if the measurement reads over 45 American Petroleum Institute (API) units. The geological event pattern can be defined as a relative change in a gamma ray measurement that is over a set percentage higher than the previous and preceding measurements. The geological event pattern can be across multiple logs. For example, the magnitude of separation between a top-bin reading and a bottom-bin reading of an azimuthal gamma ray tool could be a pattern that when the magnitude reaches a desired threshold, a geological event pattern is identified that indicates a direction of formation boundary penetration. The geological event pattern can be for a formation property measurement and a pseudo log. For example, the percentage change between the formation property and the geological model can be a biased interpretation of the geology.

At block 405, the pattern-based control point detector determines if the formation property measurements match the geological event pattern. As described above, the formation properties can match the geological event pattern depending on how the pattern is defined. A pattern match may be satisfying a rule or being within a margin of deviation of a trend or curve as defined by a function. A margin of variance can be tolerated for pattern matching due to noise that can be introduced into the measurements and the complexity of geological formations. Multiple patterns can be matched in a single dataset of measurements. For example, if the set of formation property measurements comprises data spanning 1,000 ft of wellbore, then multiple points along the 1,000 ft of measurements can match with the geological event patterns. If a pattern is matched, operational flow proceeds to block 406. Otherwise, operational flow proceeds to block 407.

At block 406, the pattern-based control point detector labels the depth of the geological event identified by the pattern match and the corresponding formation property as a control point. Labeling the control point can be setting a flag or value associated with the formation property measurements and corresponding wellbore position data.

At block 407, the pattern-based control point detector determines whether there is another formation property indicated in the measurements. If there is an additional formation property and a control point has not already been identified, then operational flow returns to block 402. In some instances, operational flow can proceed to block 402 if a control point has been identified in the current formation property measurement, but with a lack of confidence (i.e., a noise level in the measurements exceeds a predefined threshold or a geologist requires multiple formation property measurements due to geological formation complexity), and further confirmation is needed from additional formation properties indicated in the measurements. Operational flow proceeds to block 408 if a control point has been identified in a formation property measurement. In some instances, operational flow may proceed to block 408 if a control point has been identified in formation property measurement and there are additional formation property measurements that have not been evaluated by the pattern-based control point detector. In some instances, operational flow proceeds to block 408 once a control point is identified in a formation property measurement and confirmed across one or more additional formation property measurements.

At block 408, the pattern-based control point detector communicates the control point for interpretation. The control point can be passed on for manual interpretation to a human operator, such as a geologist, or to geosteering software that can automatically interpret the control point. Additionally, the other formation property measurements at the depth of the control point can be communicated for interpretation to update the geological model.

FIG. 5 is a flowchart example of operations of pattern recognition-based detection of geological events in formation property(ies) measurements. The example operations in FIG. 5 are described with reference to a pattern-based control point detector for consistency with FIG. 4. The operations of FIG. 5 can be repeated for every predefined geological event pattern. The corresponding measurements of each pattern can span across multiple formation property measurements. The operations of FIG. 5 are similar to FIG. 4 but address a scenario of search for each predefined geological event pattern in formation property(ies) measurements.

At block 501, the pattern-based control point detector obtains formation property(ies) measurements. This is similar to block 401 of FIG. 4.

At block 502 the pattern-based control point detector begins searching for each predefined geological event pattern in the obtained measurements. Depending upon resources, the pattern-based control point detector may search for the patterns in parallel. If sequential, the patterns can be prioritized according to likely impact on steering decision and/or the geological model.

At block 503, the pattern-based control point detector determines if there are sufficient measurements for the formation property(ies) corresponding to the geological event pattern. If the pattern requires multiple formation properties, the pattern-based control detector determines if the formation properties are available in the measurements. Some patterns may be defined for one formation property. If the corresponding formation properties are available, the detector also confirms there are sufficient measurements of the corresponding formation property(ies). If the appropriate measurements are available and sufficient for pattern detection, then operational flow proceeds to block 504. Otherwise, operational flow proceeds to block 507.

At block 504, the pattern-based control point detector evaluates corresponding measurements against the predefined pattern. In some cases, a pattern is defined for multiple formation properties. For instance, a pattern may be defined as a rate of change in a first formation property depending upon a rate of change of a second formation property. A pattern may be defined as an inverse relationship between trends of different formation properties.

At block 505, the pattern-based control point detector determines if a match for the predefined geological event pattern has been found. If a pattern is matched, operational flow proceeds to block 506. Otherwise, operational flow proceeds to block 507.

At block 506, the pattern-based control point detector labels the depth of the geological event identified by the pattern match and the corresponding formation property(ies) measurements as a control point.

At block 507, the pattern-based control point detector determines if there is an additional geological event pattern to search. If so, operational flow returns to block 502. In some instances, operational flow can return to block 502 if a single geological event pattern has been found but with a lack of confidence (i.e., a noise level in the measurements exceeds a predefined threshold or a geologist requires multiple formation property measurements due to geological formation complexity) and additional geological event patterns are needed to confirm the identified geological event pattern. Operational flow proceeds to block 508 if a control point has been identified with a geological event pattern match. In some instances, operational flow may proceed to block 508 if a control point has been identified with a geological event pattern match and there are additional geological event patterns that have not been evaluated by the pattern-based control point detector. In some instances, operational flow proceeds to block 508 once a control point is identified with a geological event pattern match and confirmed across one or more additional with a geological event pattern matches which is similar to block 408 of FIG. 4.

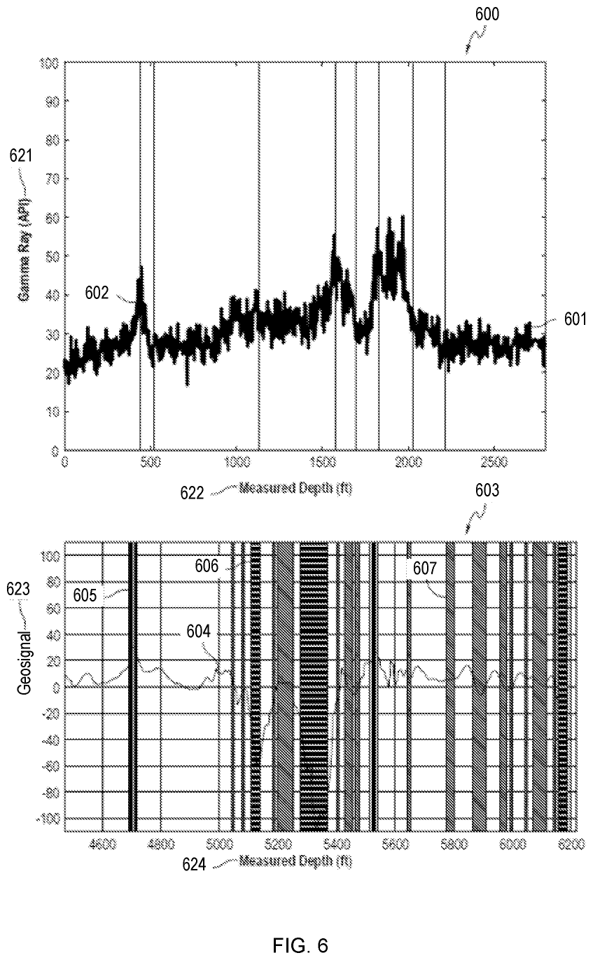

FIG. 6 illustrates various examples of geological event pattern detection in LWD measurements. Gamma ray profile 600 depicts gamma ray readings at various measured depths. The x-axis 622 comprises measured depth in feet and the y-axis 621 comprises gamma ray values measured in API. Curve 601 is the gamma ray reading at each measured depth obtained by a gamma ray tool on a drilling BHA. Abrupt changes in gamma ray readings with respect to neighboring gamma ray readings may indicate the wellbore has penetrated a formation boundary. A geological event pattern detection may be in place to identify abrupt changes in the gamma ray measurements when a threshold is met, such as geological event 602. The measured depth and gamma ray reading at geological event 602 can be labeled as a potential control point and communicated for interpretation.

Resistivity profile 603 depicts azimuthal deep resistivity readings. A single, normalized quantity of resistivity measurements may indicate the proximity of the formation boundary with respect to the resistivity tool. The x-axis 624 comprises measured depth in feet and the y-axis 623 comprises the geosignal signal for resistivity. Curve 604 is the single, normalized quantity of geosignals at each measured depth. If curve 604 is near zero such as at label 607, then there is no indication that a formation boundary is approaching. If curve 604 is positive by a certain threshold, such as label 605, then there is indication that a formation boundary is approaching at a depth deeper than the drilling BHA. If curve 604 is negative by a certain threshold, such as label 606, then there is indication that a formation boundary is approaching a depth less than the drilling BHA.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instruction stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain, or store a program for use by or in connection with an instruction execution system, apparatus, or device. A machine-readable storage medium is not a machine-readable signal medium.

A machine-readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

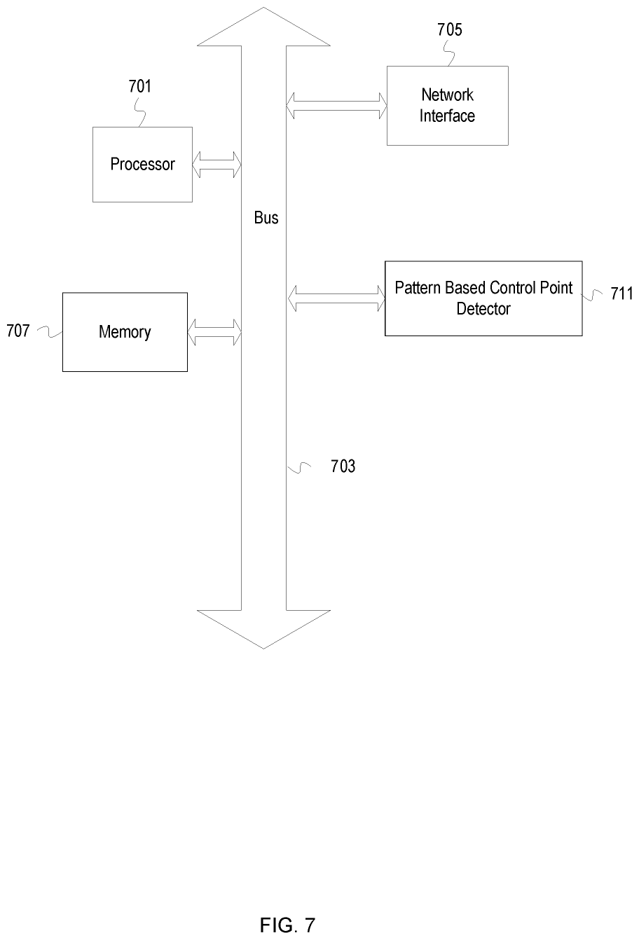

FIG. 7 depicts an example computer system with a pattern-based control point detector to identify potential control points for interpretation. The computer system includes a processor 701 (possibly including multiple processors, multiple cores, multiple nodes, and/or implementing multi-threading, etc.). The computer system includes memory 707. The memory 707 may be system memory or any one or more of the above already described possible realizations of machine-readable media. The computer system also includes a bus 703 and a network interface 705. The system also includes pattern-based control point detector 711. The pattern-based control point detector 711 identifies geological event patterns that could be potential control points. Any one of the previously described functionalities may be partially (or entirely) implemented in hardware and/or on the processor 701. For example, the functionality may be implemented with an application specific integrated circuit, in logic implemented in the processor 701, in a co-processor on a peripheral device or card, etc. Further, realizations may include fewer or additional components not illustrated in FIG. 7 (e.g., video cards, audio cards, additional network interfaces, peripheral devices, etc.). The processor 701 and the network interface 705 are coupled to the bus 703. Although illustrated as being coupled to the bus 703, the memory 707 may be coupled to the processor 701.

While the aspects of the disclosure are described with reference to various implementations and exploitations, it will be understood that these aspects are illustrative and that the scope of the claims is not limited to them. In general, techniques for identifying control points as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

### Terminology

Use of the phrase “at least one of” preceding a list with the conjunction “or” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

Embodiment 1: A method comprising: obtaining wellbore measurements while propagating a wellbore trajectory through a formation; evaluating the wellbore measurements against a plurality of predetermined patterns to determine whether at least one of the plurality of predetermined patterns is detected in the wellbore measurements, wherein each of the plurality of predetermined patterns is correlated to a geological event; based on detection of a first predetermined pattern, indicating a potential steering control point with a subset of the wellbore measurements corresponding to the detection and a location corresponding to the subset of the wellbore measurements; and indicating the steering control point for interpretation.

Embodiment 2: The method of Embodiment 1, wherein the wellbore measurements comprise measurements of a set of one or more formation properties.

Embodiment 3: The method of Embodiment 2, wherein evaluating the wellbore measurements against a plurality of predetermined patterns to determine whether at least one of the plurality of predetermined patterns is detected in the wellbore measurements comprises evaluating measurements of each formation property against the set of predetermined patterns.

Embodiment 4: The method of Embodiment 3, wherein evaluating measurements of each formation property against the set of predetermined patterns comprises, for each formation property, identifying which of the predetermined patterns corresponds to the formation property and evaluating the measurements of the formation property against those of the predetermined patterns identified as corresponding to the formation property.

Embodiment 5: The method of Embodiment 1, wherein the wellbore measurements comprise wellbore position measurements.

Embodiment 6: The method of Embodiment 5, wherein evaluating the wellbore measurements against a plurality of predetermined patterns to determine whether at least one of the plurality of predetermined patterns is detected in the wellbore measurements comprises evaluating the wellbore position measurements against the set of predetermined patterns.

Embodiment 7: The method of Embodiment 1, wherein the at least one of a depth corresponding to the steering control point and the first predetermined pattern corresponding to the steering control point is communicated to an interpreter for interpretation.

Embodiment 8: The method of Embodiment 1, wherein interpretation of the steering control point is performed by manual interpretation or automated interpretation.

Embodiment 9: The method of Embodiment 1, wherein a predetermined pattern is represented with at least one of function and a set of one or more conditions that relate to magnitude, rate of change, or relative changes between different types of wellbore measurements.

Embodiment 10: A non-transitory, computer-readable medium having program code stored thereon, the program code comprising instructions to: obtain wellbore measurements while propagating a wellbore trajectory through a formation; evaluate the wellbore measurements against a plurality of predetermined patterns to determine whether at least one of the plurality of predetermined patterns is detected in the wellbore measurements, wherein each of the plurality of predetermined patterns is correlated to a geological event; based on detection of a first predetermined pattern, indicate a potential steering control point with a subset of the wellbore measurements corresponding to the detection and a location corresponding to the subset of the wellbore measurements; and indicate the steering control point for interpretation.

Embodiment 11: The non-transitory, computer-readable medium of Embodiment 10, wherein the wellbore measurements comprise measurements of a set of one or more formation properties.

Embodiment 12: The non-transitory, computer-readable medium of Embodiment 11, wherein the instructions to evaluate the wellbore measurements against a plurality of predetermined patterns to determine whether at least one of the plurality of predetermined patterns is detected in the wellbore measurements comprise instructions to evaluate measurements of each formation property against the set of predetermined patterns.

Embodiment 13: The non-transitory, computer-readable medium of Embodiment 12, wherein the instructions to evaluate measurements of each formation property against the set of predetermined patterns comprise instructions to identify, for each formation property, which of the predetermined patterns corresponds to the formation property and evaluate the measurements of the formation property against those of the predetermined patterns identified as corresponding to the formation property.

Embodiment 14: The non-transitory, computer-readable medium of Embodiment 10, wherein the wellbore measurements comprise wellbore position measurements.

Embodiment 15: The non-transitory, computer-readable medium of Embodiment 14, wherein the instructions to evaluate the wellbore measurements against a plurality of predetermined patterns to determine whether at least one of the plurality of predetermined patterns is detected in the wellbore measurements comprise instructions to evaluate the wellbore position measurements against the set of predetermined patterns.

Embodiment 16: The non-transitory, computer-readable medium of Embodiment 10, wherein the at least one of a depth corresponding to the steering control point and the first predetermined pattern corresponding to the steering control point is communicated to an interpreter for interpretation.

Embodiment 17: The non-transitory, computer-readable medium of Embodiment 10, wherein interpretation of the steering control point is performed by manual interpretation or automated interpretation.

Embodiment 18: The non-transitory, computer-readable medium of Embodiment 10, wherein a predetermined pattern is represented with at least one of function and a set of one or more conditions that relate to magnitude, rate of change, or relative changes between different types of wellbore measurements.

Embodiment 19: An apparatus comprising: a processor; memory having stored therein a plurality of predetermined patterns each of which is correlated to a geological event; and a computer-readable medium having instructions stored thereon that are executable by the processor to cause the apparatus to, obtain wellbore measurements corresponding to propagation of a wellbore trajectory through a formation; evaluate the wellbore measurements against the plurality of predetermined patterns to determine whether at least one of the plurality of predetermined patterns is detected in the wellbore measurements; based on detection of a first predetermined pattern, indicate a potential steering control point with a subset of the wellbore measurements corresponding to the detection and a location corresponding to the subset of the wellbore measurements; and indicate the steering control point for interpretation.

Embodiment 20: The apparatus of Embodiment 19, wherein a predetermined pattern is represented with at least one of function and a set of one or more conditions that relate to magnitude, rate of change, or relative changes between different types of wellbore measurements.

1. A method comprising:
obtaining wellbore measurements while propagating a wellbore trajectory through a formation;
evaluating the wellbore measurements against a plurality of predetermined patterns to determine whether at least one of the plurality of predetermined patterns is detected in the wellbore measurements, wherein each of the plurality of predetermined patterns is correlated to a geological event;
based on detection of a first predetermined pattern, indicating a potential steering control point with a subset of the wellbore measurements corresponding to the detection and a location corresponding to the subset of the wellbore measurements; and
indicating the steering control point for interpretation.

2. The method of claim 1, wherein the wellbore measurements comprise measurements of a set of one or more formation properties.

3. The method of claim 2, wherein evaluating the wellbore measurements against the plurality of predetermined patterns to determine whether at least one of the plurality of predetermined patterns is detected in the wellbore measurements comprises evaluating measurements of each formation property against the set of predetermined patterns.

4. The method of claim 3, wherein evaluating measurements of each formation property against the set of predetermined patterns comprises, for each formation property, identifying which of the predetermined patterns corresponds to the formation property and evaluating the measurements of the formation property against those of the predetermined patterns identified as corresponding to the formation property.

5. The method of claim 1, wherein the wellbore measurements comprise wellbore position measurements.

6. The method of claim 5, wherein evaluating the wellbore measurements against the plurality of predetermined patterns to determine whether at least one of the plurality of predetermined patterns is detected in the wellbore measurements comprises evaluating the wellbore position measurements against the set of predetermined patterns.

7. The method of claim 1, wherein the at least one of a depth corresponding to the steering control point and the first predetermined pattern corresponding to the steering control point is communicated to an interpreter for interpretation.

8. The method of claim 1, wherein interpretation of the steering control point is performed by manual interpretation or automated interpretation.

9. The method of claim 1, wherein a predetermined pattern is represented with at least one of function and a set of one or more conditions that relate to magnitude, rate of change, or relative changes between different types of wellbore measurements.

10. A non-transitory, computer-readable medium having program code stored thereon, the program code comprising instructions to:
obtain wellbore measurements while propagating a wellbore trajectory through a formation;
evaluate the wellbore measurements against a plurality of predetermined patterns to determine whether at least one of the plurality of predetermined patterns is detected in the wellbore measurements, wherein each of the plurality of predetermined patterns is correlated to a geological event;
based on detection of a first predetermined pattern, indicate a potential steering control point with a subset of the wellbore measurements corresponding to the detection and a location corresponding to the subset of the wellbore measurements; and
indicate the steering control point for interpretation.

11. The non-transitory, computer-readable medium of claim 10, wherein the wellbore measurements comprise measurements of a set of one or more formation properties.

12. The non-transitory, computer-readable medium of claim 11, wherein the instructions to evaluate the wellbore measurements against the plurality of predetermined patterns to determine whether at least one of the plurality of predetermined patterns is detected in the wellbore measurements comprise instructions to evaluate measurements of each formation property against the set of predetermined patterns.

13. The non-transitory, computer-readable medium of claim 12, wherein the instructions to evaluate measurements of each formation property against the set of predetermined patterns comprise instructions to identify, for each formation property, which of the predetermined patterns corresponds to the formation property and evaluate the measurements of the formation property against those of the predetermined patterns identified as corresponding to the formation property.

14. The non-transitory, computer-readable medium of claim 10, wherein the wellbore measurements comprise wellbore position measurements.

15. The non-transitory, computer-readable medium of claim 14, wherein the instructions to evaluate the wellbore measurements against the plurality of predetermined patterns to determine whether at least one of the plurality of predetermined patterns is detected in the wellbore measurements comprise instructions to evaluate the wellbore position measurements against the set of predetermined patterns.

16. The non-transitory, computer-readable medium of claim 10, wherein the at least one of a depth corresponding to the steering control point and the first predetermined pattern corresponding to the steering control point is communicated to an interpreter for interpretation.

17. The non-transitory, computer-readable medium of claim 10, wherein interpretation of the steering control point is performed by manual interpretation or automated interpretation.

18. The non-transitory, computer-readable medium of claim 10, wherein a predetermined pattern is represented with at least one of function and a set of one or more conditions that relate to magnitude, rate of change, or relative changes between different types of wellbore measurements.

19. An apparatus comprising:
a processor;
memory having stored therein a plurality of predetermined patterns each of which is correlated to a geological event; and
a computer-readable medium having instructions stored thereon that are executable by the processor to cause the apparatus to,
obtain wellbore measurements corresponding to propagation of a wellbore trajectory through a formation;
evaluate the wellbore measurements against the plurality of predetermined patterns to determine whether at least one of the plurality of predetermined patterns is detected in the wellbore measurements;
based on detection of a first predetermined pattern, indicate a potential steering control point with a subset of the wellbore measurements corresponding to the detection and a location corresponding to the subset of the wellbore measurements; and
indicate the steering control point for interpretation.

20. The apparatus of claim 19, wherein a predetermined pattern is represented with at least one of function and a set of one or more conditions that relate to magnitude, rate of change, or relative changes between different types of wellbore measurements.
